(19) United States
(12) Patent Application Publication
(10) Pub. No.: US 2016/0145929 A1
(43) Pub. Date: May 26, 2016

(54) SAFE WITH RECESSED KEYPAD AND OPENING DISC

(71) Applicant: John B. Adrain, Frisco, TX (US)

(72) Inventor: John B. Adrain, Frisco, TX (US)

(21) Appl. No.: 14/950,150

(22) Filed: Nov. 24, 2015

Related U.S. Application Data
(60) Provisional application No. 62/084,133, filed on Nov. 25, 2014.

(51) Int. Cl. E05G 1/026; E05G 1/06; E05G 1/04

(52) U.S. Cl. CPC E05G 1/026; E05G 1/04; E05G 1/06

(57) ABSTRACT

A safe that is configured to be used as part of furniture having a door with access control features and a door opening mechanism that are provided flush, substantially flush, or below an outer surface of the door such that the safe is hidden by the furniture to hide the fact that it is present as part of the furniture.

### CROSS-REFERENCES TO RELATED APPLICATIONS

This application claims the benefit of U.S. Provisional Patent Application Ser. No. 62/084,133 filed on Nov. 25, 2014, incorporated herein by reference.

### BACKGROUND

Generally, safes are useful for protecting valuable items and/or firearms from theft and unacceptable access. Safes typically use protruding combination locks and levers to lock and provide access to the safe. Such a design is useful in most situations where a safe is not provided in close quarters or covered by a flat object, but in such circumstances, a safe with flush features may be beneficial.

### SUMMARY

Provided are a plurality of example embodiments, including, but not limited to, a safe having a door with a data input device provided therein that is substantially flush or below an outer surface of the door; and a door opening structure is provided as an access mechanism for obtaining access to the safe, the access mechanism being placed flush to the door or below the door that is rotated to open the safe when the safe is unlocked by the entry of a proper code in the data entry keypad.

Also provided is a safe mounting structure for use as part of an item of furniture, comprising: at least one compartment surrounded by walls and having an opening; a door configured with a lock to securely close the opening, the door including at least one recess within an outer surface of the door; a door opening structure configured to open the door when actuated; and an input device configured to receive an input combination. The door opening structure and the input device are each configured to be flush or substantially flush with the outer surface of the door. Furthermore, either the keypad or the door opening structure is provided within the recess. Also, the outer surface of the door of the safe is adapted accept a part of the furniture as a cover to hide the door.

Also provided is safe mounting structure for use as part of an item of furniture, comprising: a first and second safe placed side-by-side, each safe comprising: at least one compartment surrounded by walls and having an opening, a door configured with a lock to securely close the opening, the door including at least one recess within an outer surface of the door, a door opening structure configured to open the door when actuated, an input device configured to receive an input combination, and a plurality of feet provided on a surface of the safe provided opposite the door, where the door opening structure and the input device are each configured to be flush or substantially flush with the outer surface of the door, and where either the keypad or the door opening structure is provided within the recess; a support structure configured to extend a portion of the outer surface of one or both of the safes; and a furniture part configured to cover the support structure and the outer surface of the doors of both of the safes to hide the doors of the safes.

Also provided are any of the safe mounting structures discussed above, wherein said door opening structure is formed into a circular disk or a recessed lever.

Still further provided is a method of opening a safe comprising the steps of entering a predetermined code into a keypad; and rotating a disk mounted flush to a wall of the safe to open a door of the safe.

Also provided are additional example embodiments, some, but not all of which, are described hereinbelow in more detail.

### BRIEF DESCRIPTION OF THE DRAWINGS

The features and advantages of the example embodiments described herein will become apparent to those skilled in the art to which this disclosure relates upon reading the following description, with reference to the accompanying drawings, in which:

FIG. 1 is a schematic diagram of an example door of an example embodiment of an example safe;

FIG. 2 is a schematic diagram of a pair of the example safes placed side-by-side with one of the safes in a closed state and the other of the safes in a partially open state using the example door of FIG. 1;

FIG. 3 is a schematic diagram of another example door of another example embodiment of another safe; and

FIGS. 4a, 4b are schematic diagrams of different views of the pair of safes of FIG. 2 used as part of an example item of furniture.

### DETAILED DESCRIPTION OF THE EXAMPLE EMBODIMENTS

Disclosed are embodiments of safes having mechanical structures used for locking and opening the safes provided in a manner that is flush, or nearly flush, with a wall or door of the safe. This allows the safe to be used in locations where there is a tight fit between the safe and another structure, or it allows the safe to be used hidden in or under furniture or other fixtures.

For example, U.S. Pat. No. 6,082,272, incorporated herein by reference, discloses a safe that is used under a mattress in a bed. By making the opening and locking mechanisms flush or nearly flush with one wall or door of the safe, the safe can be better hidden from view, by covering the mechanisms with the mattress of the bed, for example.

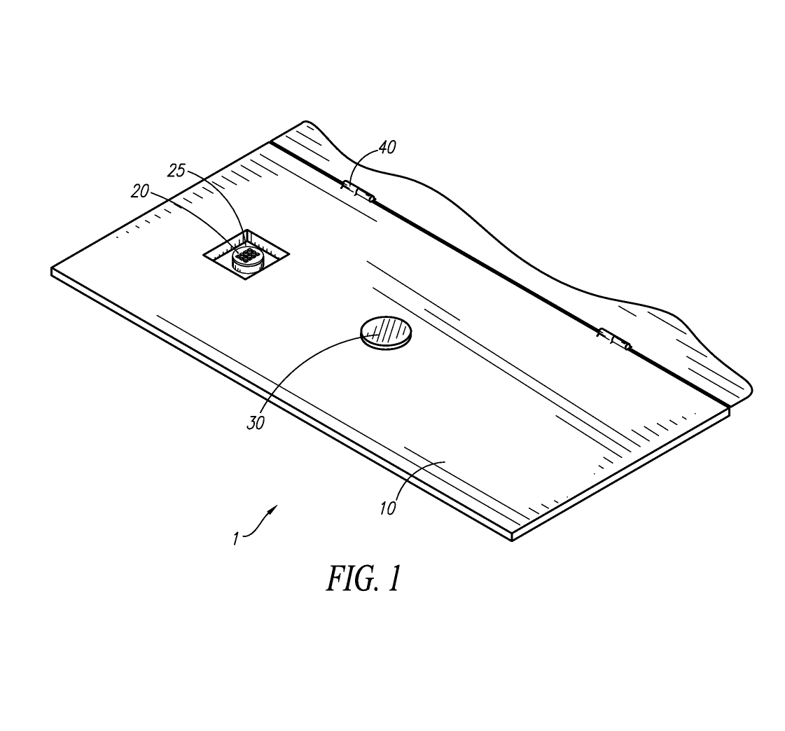

FIG. 1 shows an example embodiment of the door 10 of an example safe 1 (partially shown) having the flush and nearly flushed features. The wall or door 10 is provided for a safe, having a recessed portion 25 for receiving an input device for receiving a code for opening the safe, such as, for example, a keypad 20. In this example, the keypad 20 is provided completely within the recessed portion 25 and hence does not extend beyond the outer surface of the door 110. The keypad 20 can be of a type known in the art for securing doors and safes, in that the keypad 20 is an electronic device that is adapted to receive a predetermined code for locking and/or unlocking the safe. The predetermined code is typically programmed into the keypad device, which may be computerized (and battery powered), in advance. When a proper code is entered, the keypad 20, which can be battery operated using a long-life battery, applies a signal to a locking mechanism to unlock or allow the safe or door to be unlocked and hence opened.

The safe door 10 also has a door opening structure 30 that acts as an access mechanism that is used to open the door of the safe when the safe has been properly unlocked using the keypad 20. In this example embodiment, the opening structure is provided as a flat disk that is nearly flush against a surface of the wall or door 10 to minimize protrusion from the wall or door 10. In this example shown in FIG. 1, the opening structure is a flat disk that is operated by turning the disk, such as by gripping a perimeter of the disk, or by placing the palm of a hand on the outer surface of the disk and rotating the disk using friction between the palm and the outer disk surface.

The door opening structure can be used to lock the safe when turned in one direction (e.g., counterclockwise) and open the (unlocked) safe when turned in the opposite direction (e.g., clockwise), for example. In such a device, the door opening structure, when actuated, extends or retracts one or more locking bolts that lock the door, for example. Typically, the door opening structure cannot retract the bolt(s) until a proper code is entered in the input device to unlock the door.

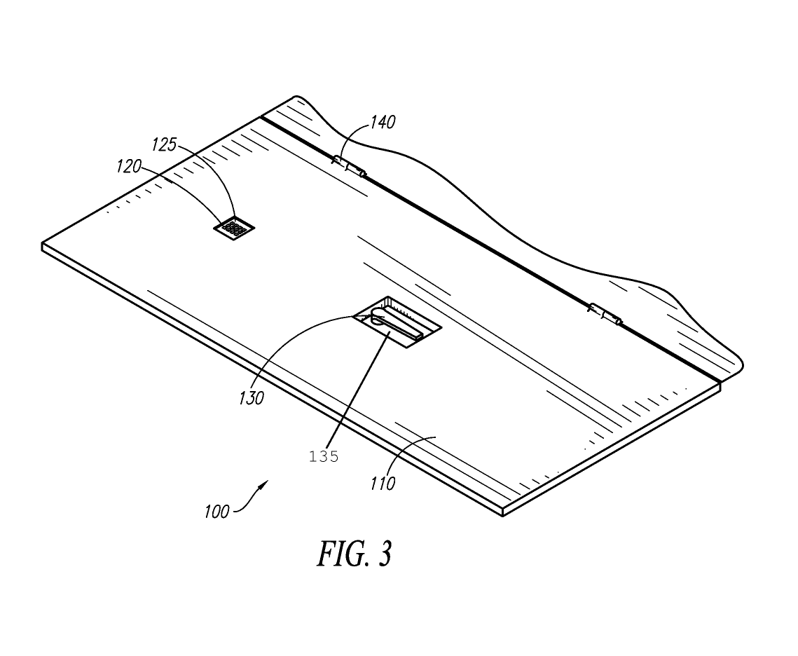

Alternatively, the door opening structure could be implemented using a lever or other device that is provided flush against the surface of the wall or door, as desired, as shown in another example embodiment of a door 110 for a safe 100 shown in FIG. 3. In this example, a more conventional safe lever 130 is provided in the recessed portion 135 to open the door 110. This lever could be provided so that it does not extend beyond the outer surface of the door 110, or it might be substantially below the outer surface or it might slightly protrude from the outer surface. The recess 135 should provide sufficient space to allow the lever to be operated to unlatch and open the door 110.

A keypad 120 is also provided as an input device, which is shown as a rectangle completely filling the perimeter of the recess 125, but which is still provided completely within the recess. Alternatively, the keypad 120 could be provided in the door of the safe with the individual keys flush with the outer surface of the door, or even slightly protruding from the outer surface of the door 110, in which case a lock may be provided to disable the keys to avoid inadvertent actuation that might drain any battery powering the keypad and lock mechanism. Note that the input device might be implanted using a touch screen or a combination lock, or a key or set of keys, rather than a keypad, for example.

In the Examples of FIGS. 1 & 2, the wall or door 10, 110 is a door as evidence by the hinge 40, and hence the respective safe 1, 100 is opened by rotating the door 10, 110 outward after operating the respective access mechanism 30, 130 when it has been unlocked using the respective keypad 20, 120.

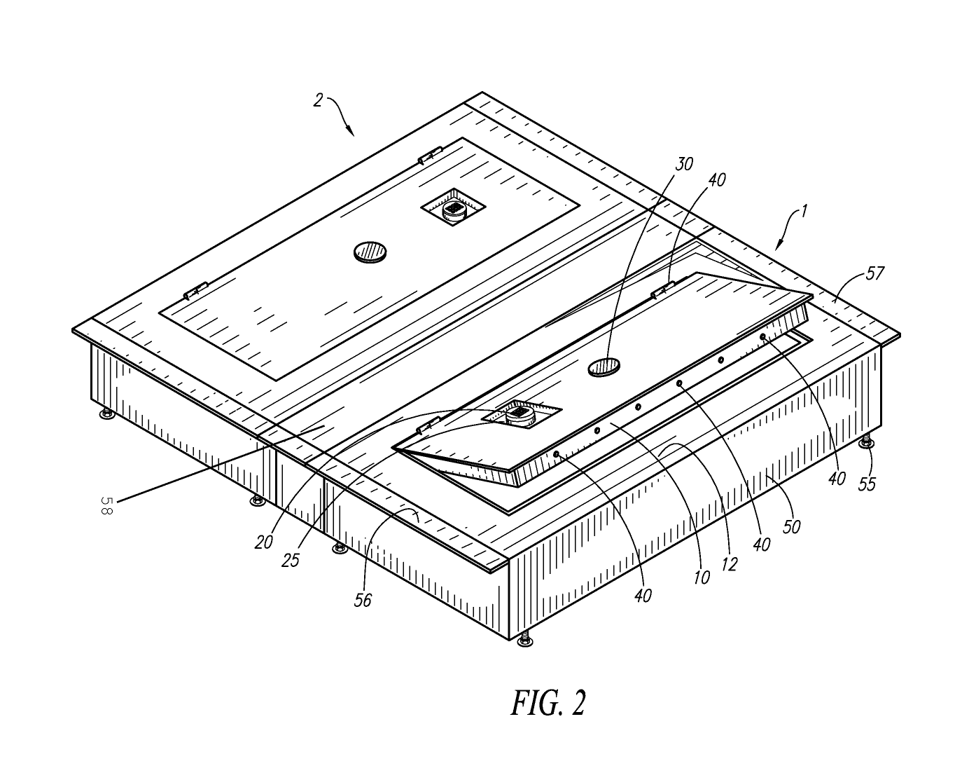

FIG. 2 shows an example of a pair of safes 1, 2 using doors as shown in FIG. 1, with the safes placed side-by-side for use as a base for a bed (such as disclosed in the '272 patent), with safe 2 shown in a closed position and safe 1 shown in a partially opened position, with door 10 ajar showing locking shafts 40 in a recessed position. The locking shafts (bolts) 40 are used to lock the door when closed by engaging corresponding receiving receptacles (not shown) provided in the inner wall of the wall portion 12. Feet 55 can be provided to lift the safe to the desired height for the bed, and lips 56, 57 extend the length of the safes to match a length of a mattress to be used on the bed. Similar lips could be used on the other two sides of the safe, as desired for the given size of bed and safe. A center console 58 can also be provided to adjust the width of the two safes to the desired dimensions to support the desired application. This console may include an additional inner volume for storage, if desired. In this case, the access mechanism 30 and keypad 20 are placed next to the base of the mattress substantially flush with the mattress, providing little obstruction and completely hiding the fact that the mattress is resting on a pair of safes.

The safe 1 is shown with side wall 50, among others. Note that when desired, the keypad 20 in recess 25, and/or the access mechanism 30, could be installed in another wall, such as wall 50, rather than in the door 10. In such circumstances, the door 10 may be spring loaded to more easily open when unlocked and the access mechanism is operated, or alternatively a slot or other gripping feature may be provided on the door 10 to be used by an operator to pull the door 10 open.

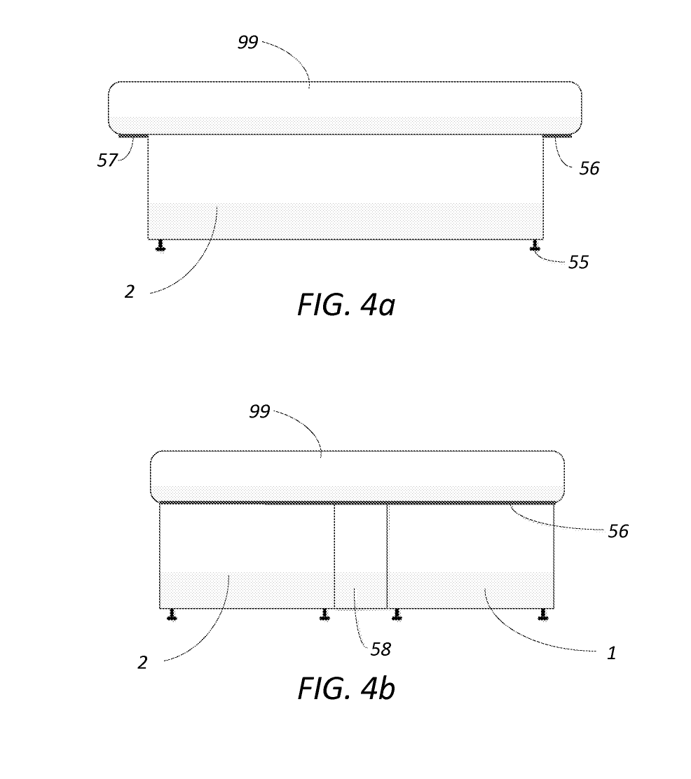

FIGS. 4a, 4b show an example where the safes 1, 2 of FIG. 2 are used to support a mattress 99 to form a bed, with FIG. 4a showing a side of the bed, and FIG. 4b showing the head or foot of the bed, for example. If desired, customized furniture or boarding or other faux surface may be used to cover the sides of the safe for any of the four sides, for a more pleasing look and to further disguise that a compartment is provided under the mattress.

As alternatives, the safes could be configured to also support a box spring under the mattress, and sides of the safe (e.g., the lips) might be extended 90 degrees to support the sides of the box spring and/or the mattress, as desired.

In addition to use in a bed, as discussed above, such a safe may be made part of other types of furniture, such as in a sofa (couch), chair, bench, or other furniture, or behind a bookcase, or other fixture. For example, when used in a couch a single safe could be provided in the base of the couch and covered with a cushion. Use of a hidden safe is disclosed in U.S. patent application Ser. No. 14/299,167 filed on Jun. 9, 2014, and incorporated herein by reference. Such a device as disclosed in the '167 application could be modified as discussed herein to provide a more flush approach. Use in other types of furniture, fixtures, or other applications can be similarly utilized.

Alternatively, the door of FIG. 3 might be used in a similar manner for an alternative safe door design for the examples shown in FIGS. 2 and 4. Other door examples could also be provided.

Additional alternatives include providing another door to cover the recesses that contain the input device or opening structure, or both, to further conceal the function of the safe.

Furthermore, in any of the above embodiments, the input device and/or the door opening structure could be provided in a wall of the safe, with the door being provided in another wall (side) of the safe or provided in part of the same wall as the input device and access mechanisms, as desired.

Many other example embodiments can be provided through various combinations of the above described features. Although the embodiments described hereinabove use specific examples and alternatives, it will be understood by those skilled in the art that various additional alternatives may be used and equivalents may be substituted for elements and/or steps described herein, without necessarily deviating from the intended scope of the application. Modifications may be necessary to adapt the embodiments to a particular situation or to particular needs without departing from the intended scope of the application. It is intended that the application not be limited to the particular example implementations and example embodiments described herein, but that the claims be given their broadest reasonable interpretation to cover all novel and non-obvious embodiments, literal or equivalent, disclosed or not, covered thereby.

What is claimed is:

1. A safe mounting structure for use as part of an item of furniture, comprising:
at least one compartment surrounded by walls and having an opening;
a door configured with a lock to securely close said opening, said door including at least one recess within an outer surface of said door;
a door opening structure configured to open the door when actuated; and
an input device configured to receive an input combination, wherein
said door opening structure and said input device are each configured to be flush or substantially flush with the outer surface of said door, and wherein
either said keypad or said door opening structure is provided within said recess, and wherein
the outer surface of the door of the safe is adapted accept a part of the furniture as a cover to hide the door.

2. The safe mounting structure of claim 1, wherein said input device includes a keypad that is provided within said recess such that keys of said keypad are provided completely below the outer surface of said door.

3. The safe mounting structure of claim 2, wherein said door opening structure is a disk that is provided flat against said outer surface of said door in a substantially flush manner.

4. The safe mounting structure of claim 2, wherein said door includes an additional recess, and wherein said door opening structure is a lever that is provided within said additional recess such that said lever is provided completely below the outer surface of said door.

5. The safe mounting structure of claim 1, wherein said door includes an additional recess, and wherein said door opening structure is a lever that is provided within said additional recess such that said lever is provided completely below the outer surface of said door.

6. The safe mounting structure of claim 1, wherein said door opening structure is a disk that is provided flat against said outer surface of said door in a substantially flush manner.

7. The safe mounting structure of claim 1, further comprising at least one lip to extend an outer surface of the safe for more fully supporting the part of the furniture.

8. The safe mounting structure of claim 1, further comprising a plurality of adjustable feet for adjusting a height of the piece of furniture.

9. The item of furniture, comprising the safe of claim 1 and further comprising a second safe according to claim 1 adapted to be also covered with said part of said furniture to also hide the outer surface of the door of the second safe.

10. The item of furniture of claim 9, further comprising a storage volume provided between the two safes.

11. A safe mounting structure for use as part of an item of furniture, comprising:
at least one compartment surrounded by walls and having an opening;
a door configured with a lock to securely close said opening, said door including at least one recess within an outer surface of said door;
an input device provided within said recess such that the input device is provided completely below the outer surface of said door, said input device being configured to receive an input combination;
a door opening structure configured to open the door when actuated that is also configured to be either flush or substantially flush with the outer surface of the door or configured to be provided in another recess to be completely below the outer surface of the door; and
a plurality of feet provided on a surface of the safe provided opposite the door, wherein
the outer surface of the door is adapted to accept a part of the furniture as a cover to hide the door.

12. The safe of claim 11, wherein said input device includes a keypad provided within said recess such that keys of said keypad are provided completely below the outer surface of said door.

13. The safe of claim 11, wherein said door opening structure is a disk that is provided flat against said outer surface of said door in a substantially flush manner.

14. The safe of claim 11, further comprising at least one lip to extend an outer surface of the safe for more fully supporting the part of the furniture.

15. The safe of claim 1, wherein said door includes the additional recess, and wherein said door opening structure is a lever that is provided within said additional recess such that said lever is provided completely below the outer surface of said door.

16. A safe mounting structure for use as part of an item of furniture, comprising:
a first and second safe placed side-by-side, each safe comprising:
at least one compartment surrounded by walls and having an opening,
a door configured with a lock to securely close said opening, said door including at least one recess within an outer surface of said door,
a door opening structure configured to open the door when actuated,
an input device configured to receive an input combination, and
a plurality of feet provided on a surface of the safe provided opposite the door, wherein
said door opening structure and said input device are each configured to be flush or substantially flush with the outer surface of said door, and wherein
either said keypad or said door opening structure is provided within said recess;
support structure configured to extend a portion of the outer surface of one or both of the safes; and
a furniture part configured to cover the support structure and the outer surface of the doors of both of said safes to hide the doors of the safes.

17. The item of furniture of claim 16, wherein said input device includes a keypad provided within said recess such that keys of said keypad are provided completely below the outer surface of said door.

18. The item of furniture of claim 16, wherein said door opening structure is a disk that is provided flat against said outer surface of said door in a substantially flush manner.

19. The item of furniture of claim 16, wherein, for each safe, the door includes an additional recess, and said door opening structure is a lever that is provided within said additional recess such that said lever is provided completely below the outer surface of said door.

20. A safe mounting structure for use as part of an item of furniture, comprising:
at least a pair of safes, each safe comprising:
at least one compartment surrounded by walls and having an opening,
a door configured with a lock to securely close said opening, said door including at least one recess within an outer surface of said door,
an input device provided within said recess such that the input device is provided completely below the outer surface of said door, said input device being configured to receive an input combination,
a door opening structure configured to open the door when actuated that is also configured to be either flush or substantially flush with the outer surface of the door or configured to be provided in another recess to be completely below the outer surface of the door, and
a plurality of feet provided on a surface of the safe provided opposite the door;
a support structure configured to extend a portion of the outer surface of one or both of the safes configured for supporting an item of furniture, wherein
the outer surface of the door of each safe is adapted to accept a part of the furniture to cover the outer surfaces to hide the doors.
